(19) United States
(12) Patent Application Publication
(10) Pub. No.: US 2022/0343220 A1
(43) Pub. Date: Oct. 27, 2022

(54) CONTROL APPARATUS, METHOD AND SYSTEM

(71) Applicant: NEC Corporation, Minato-ku, Tokyo (JP)

(72) Inventors: Anan SAWABE, Tokyo (JP); Takanori IWAI, Tokyo (JP); Kosei KOBAYASHI, Tokyo (JP)

(73) Assignee: NEC Corporation, Minato-ku, Tokyo (JP)

(21) Appl. No.: 17/640,847

(22) PCT Filed: Sep. 30, 2019
(86) PCT No.: PCT/JP2019/038455

§ 371 Date: Mar. 7, 2022

(51) Int. Cl. G06N 20/20; G06K 9/62

(52) U.S. Cl. CPC G06N 20/20; G06K 9/6227

(57) ABSTRACT

There is provided a control apparatus including a memory storing instructions, and one or more processors configured to execute the instructions to function as a plurality of learners each configured to learn an action for controlling a network, the one or more processors being further configured to set learning information of a second learner that is not mature among the plurality of learners, based on learning information of a first learner that is mature among the plurality of learners.

### BACKGROUND

### Technical Field

The present invention relates to a control apparatus, a method, and a system.

### Background Art

Various services have been provided over a network with the development of communication technologies and information processing technologies. For example, video data is delivered from a server over the network to reproduce the video data on a terminal, or a robot or the like provided in a factory or the like is remotely controlled form a server.

In recent years, technologies related to machine learning represented by deep learning have been remarkably developed. For example, PTL 1 describes that a technique is provided which is capable of improving learning efficiency even under incomplete information and achieving optimization of a whole system with regard to a learning control system. PTL 2 describes that a learning apparatus is provided which is capable of improving learning efficiency in a case that a reward and a teaching signal are given from an environment, by effectively using both of them.

In recent years, a study is underway to apply the machine learning to various fields because of usefulness of the machine learning. For example, a study is underway to apply the machine learning to controlling a game such as chess, or a robot or the like. In the case of applying the machine learning to game management, maximizing a score in the game is configured for a reward to evaluate a performance of the machine learning. In the robot controlling, achieving a goal action is configured for a reward to evaluate a performance of the machine learning. Typically, in the machine learning (reinforcement learning), the learning performance is discussed regarding a total of immediate rewards and rewards in respective episodes.

### CITATION LIST

### Patent Literature

[PTL 1] JP 2019-046422 A
[PTL 2] JP 2002-133390 A

### SUMMARY

### Technical Problem

A state in the machine learning targeted to the game and the robot can be relatively easy to define. For example, a checker on a chessboard is set as a state in a case of the chess, or a discretized position (angle) of an arm or the like is set as a state in a case of robot controlling.

However, in a case of applying the machine learning to control of network, a network state cannot be easy to set. For example, assume a case that the network state is featured using a throughput. The throughput is in an unstable situation of largely varying temporally, or a stable situation of converging at a specific value. Specifically, the network state includes variable patterns such as a stable state and an unstable state, and thus, a uniform processing such as defining a state using a checker on a chessboard cannot be performed, unlike the game.

The present invention has a main example object to provide a control apparatus, a method, and a system contributing to achieving an efficient control of network using the machine learning.

### Solution to Problem

According to a first example aspect of the present invention, there is provided a control apparatus including: a plurality of learners each configured to learn an action for controlling a network; and a learner management unit configured to set learning information of a second learner that is not mature among the plurality of learners, based on learning information of a first learner that is mature among the plurality of learners.

According to a second example aspect of the present invention, there is provided a method including: learning an action for controlling a network in each of a plurality of learners; and setting learning information of a second learner that is not mature among the plurality of learners, based on learning information of a first learner that is mature among the plurality of learners.

According to a third example aspect of the present invention, there is provided a system including: a terminal; a server configured to communicate with the terminal; and a control apparatus configured to control a network including the terminal and the server, wherein the control apparatus includes a plurality of learners each configured to learn an action for controlling the network, and a learner management unit configured to set learning information of a second learner that is not mature among the plurality of learners based on learning information of a first learner that is mature among the plurality of learners.

### Advantageous Effects of Invention

According to each of the example aspects of the present invention, provided are a control apparatus, a method, and a system contributing to achieving an efficient control of network using the machine learning. Note that, according to the present invention, instead of or together with the above effects, other effects may be exerted.

### BRIEF DESCRIPTION OF THE DRAWINGS

FIG. 1 is a diagram for describing an overview of an example embodiment;

FIG. 2 is a flowchart illustrating an example of an operation of a control apparatus according to an example embodiment;

FIG. 3 is a diagram illustrating an example of a schematic configuration of a communication network system according to the first example embodiment.

FIG. 4 is a diagram illustrating an example of a Q table;

FIG. 5 is a diagram illustrating an example of a configuration of a neural network;

FIG. 6 is a diagram illustrating an example of weights obtained by reinforcement learning;

FIG. 7 is a diagram illustrating an example of a processing configuration of a control apparatus according to the first example embodiment;

FIG. 8 is a diagram illustrating an example of information associating a throughput with a congestion level;

FIG. 9 is a diagram illustrating an example of information associating a throughput, a packet loss rate, and a congestion level with each other;

FIG. 10 is a diagram illustrating an example of information associating a feature with a network state;

FIG. 11 is a diagram illustrating an example of table information associating an action with control content;

FIG. 12 is a diagram illustrating an example of an internal configuration of a reinforcement learning performing unit;

FIG. 13 is a diagram illustrating an example of a learner management table;

FIG. 14 is a diagram for describing an operation of a learner management unit;

FIG. 15 is a flowchart illustrating an example of an operation of the control apparatus in a control mode according to the first example embodiment;

FIG. 16 is a flowchart illustrating an example of an operation of the control apparatus in a learning mode according to the first example embodiment;

FIG. 17 is a flowchart illustrating an example of the operation of the control apparatus in the learning mode according to the first example embodiment;

FIG. 18 is a diagram illustrating an example of a log generated by the learner;

FIG. 19 is a diagram for describing an operation of a learner management unit;

FIG. 20 is a diagram illustrating an example of a hardware configuration of the control apparatus.

FIG. 21 is a diagram for describing the operation of the learner management unit; and

FIG. 22 is a diagram for describing the operation of the learner management unit.

### DESCRIPTION OF THE EXAMPLE EMBODIMENTS

First of all, an overview of an example embodiment will be described. Note that reference signs in the drawings provided in the overview are for the sake of convenience for each element as an example to promote better understanding, and description of the overview is not to impose any limitations. Note that, in the Specification and drawings, elements to which similar descriptions are applicable are denoted by the same reference signs, and overlapping descriptions may hence be omitted.

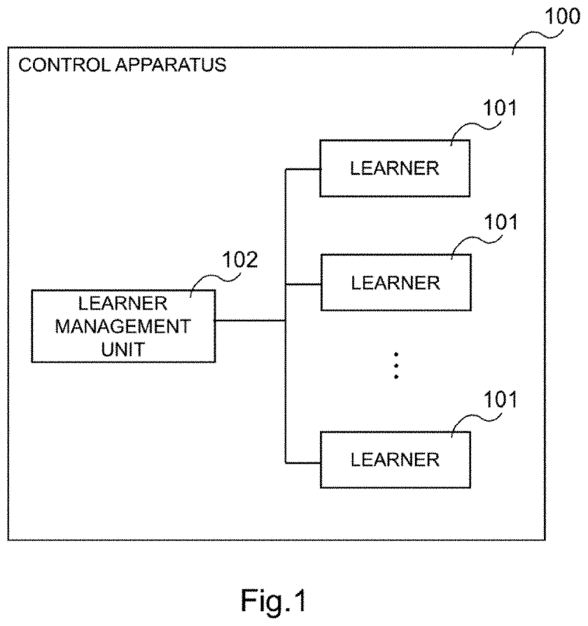

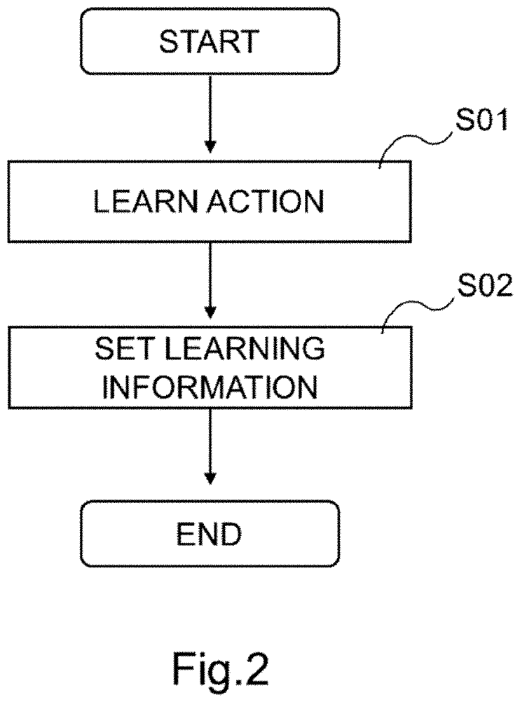

A control apparatus 100 according to an example embodiment includes a plurality of learners 101 and a learner management unit 102 (see FIG. 1). Each of the plurality of learners 101 learns an action for controlling a network (step S01 in FIG. 2). The learner management unit 102 sets learning information of a second learner 101 that is not mature among the plurality of learners 101, based on learning information of a first learner 101 that is mature among the plurality of learners 101 (step S02 in FIG. 2).

The network state includes variable patterns such as a stable state and an unstable state, and thus, a huge state space is required in a case of learning by a single learner and the learning may not be converged. As such, the control apparatus 100 uses the plurality of learners 101 to learn an action for controlling the network state. However, in the case of using the plurality of learners 101, a bias occurs in learning progresses of the respective learners 101 so that an immature learner 101 (a learner 101 not progressing the learning) increases. Accordingly, the control apparatus 100 sets the learning information (for example, Q table, weights) of the immature learner 101 to the learning information of the mature learner 101 to promote the learning of the immature learner 101. As a result, the mature learner 101 can be early acquired to allow an efficient control of network using the machine learning to be achieved.

Hereinafter, specific example embodiments are described in more detail with reference to the drawings.

### First Example Embodiment

A first example embodiment will be described in further detail with reference to the drawings.

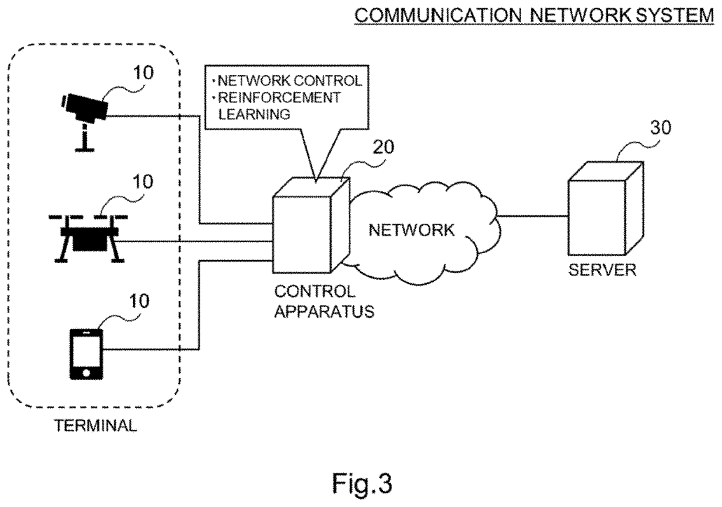

FIG. 3 is a diagram illustrating an example of a schematic configuration of a communication network system according to the first example embodiment. With reference to FIG. 3, the communication network system is configured to include a terminal 10, a control apparatus 20, and a server 30.

The terminal 10 is an apparatus having a communication functionality. Examples of the terminal 10 include a WEB camera, a security camera, a drone, a smartphone, a robot. However, the terminal 10 is not intended to be limited to the WEB camera and the like. The terminal 10 can be any apparatus having the communication functionality.

The terminal 10 communicates with the server 30 via the control apparatus 20. Various applications and services are provided by the terminal 10 and the server 30.

For example, in a case that the terminal 10 is a WEB camera, the server 30 analyzes image data from the WEB camera, so that material management in a factory or the like is performed. For example, in a case that the terminal 10 is a drone, a control command is transmitted from the server 30 to the drone, so that the drone carries a load or the like. For example, in a case that the terminal 10 is a smartphone, a video is delivered toward the smartphone from the server 30, so that a user uses the smartphone to view the video.

The control apparatus 20 is an apparatus controlling the network including the terminal 10 and the server 30, and is, for example, communication equipment such as a proxy server and a gateway. The control apparatus 20 varies values of parameters in a parameter group for a Transmission Control Protocol (TCP) or parameters in a parameter group for buffer control to control the network.

An example of the TCP parameter control includes changing a flow window size. Examples of buffer control include, in queue management of a plurality of buffers, changing the parameters related to a guaranteed minimum band, a loss rate of a Random Early Detection (RED), a loss start queue length, and a buffer length.

Note that in the following description, a parameter having an effect on communication (traffic) between the terminal 10 and the server 30, such as the TCP parameters and the parameters for the buffer control, is referred to as a “control parameter”.

The control apparatus 20 varies the control parameters to control the network. The control apparatus 20 may perform the control of network when the apparatus itself (the control apparatus 20) performs packet transfer, or may perform the control of network by instructing the terminal 10 or the server 30 to change the control parameter.

In a case that a TCP session is terminated by the control apparatus 20, for example, the control apparatus 20 may change a flow window size of the TCP session established between the control apparatus 20 and the terminal 10 to control the network. The control apparatus 20 may change a size of a buffer storing packets received from the server 30, or may change a period for reading packets from the buffer to control the network.

The control apparatus 20 uses the “machine learning” for the control of network. To be more specific, the control apparatus 20 controls the network on the basis of a learning model obtained by the reinforcement learning.

The reinforcement learning includes various variations, and, for example, the control apparatus 20 may control the network on the basis of learning information (Q table) obtained as result of the reinforcement learning referred to as Q-learning.

### [Q-Learning]

Hereinafter, the Q-learning will be briefly described.

The Q-learning makes an “agent” learn to maximize “value” in a given “environment”. In a case that the Q-learning is applied to a network system, the network including the terminal 10 and the server 30 is an “environment”, and the control apparatus 20 is made to learn to optimize a network state.

In the Q-learning, three elements, a state s, an action a, and a reward r, are defined.

The state s indicates what state the environment (network) is in. For example, in a case of the communication network system, a traffic (for example, throughput, average packet arrival interval, or the like) corresponds to the state s.

The action a indicates a possible action the agent (the control apparatus 20) may take on the environment (the network). For example, in the case of the communication network system, examples of the action a include changing configuration of parameters in the TCP parameter group, an on/off operation of the functionality, or the like.

The reward r indicates what degree of evaluation is obtained as a result of taking an action a by the agent (the control apparatus 20) in a certain state s. For example, in the case of the communication network system, the control apparatus 20 changes part of the TCP parameters, and as a result, if a throughput is increased, a positive reward is decided, or if a throughput is decreased, a negative reward is decided.

In the Q-learning, the learning is pursued to not maximize a reward (immediate reward) obtained at a current time point, but maximize value over a future is maximized (a Q table is established). The learning by the agent in the Q-learning is performed so that value (a Q-value, state-action value) when an action a in a certain state s is taken is maximized.

The Q-value (the state-action value) is expressed as Q(s, a). In the Q-learning, an action transitioned to a state of higher value by the agent taking the action is assumed to have value with a degree similar to a transition destination. According to such an assumption, a Q-value at a current time point t can be expressed by a Q-value at the next time point t+1 as below (see Equation (1)).

[Math. 1]

Q(sₜ,aₜ)=Eₛ_{ₜ₊₁}(rₜ₊₁+γEₐ_{ₜ₊₁}(Q(sₜ₊₁,aₜ₊₁))) (1)

Note that in Equation (1), rₜ₊₁ represents an immediate reward, Esₜ₊₁ represents an expected value for a state Sₜ₊₁, and Eaₜ₊₁ represents an expected value for an action aₜ₊₁. γ represents a discount factor.

In the Q-learning, the Q-value is updated in accordance with a result of taking an action a in a certain state s. Specifically, the Q-value is updated in accordance with Relationship (2) below.

[Math. 2]

Q(sₜ,aₜ)←(1−α)Q(sₜ,aₜ)+α(rₜ₊₁+γ maxₐ_{ₜ₊₁}Q(sₜ₊₁,aₜ₊₁)) (2)

In Relationship (2), a represents a parameter referred to as a learning rate, which controls the update of the Q-value. In Relationship (2), “max” represents a function to output a maximum value for the possible actions a in the state Sₜ₊₁. Note that a scheme for the agent (the control apparatus 20) to take the action a may be a scheme called ε-greedy.

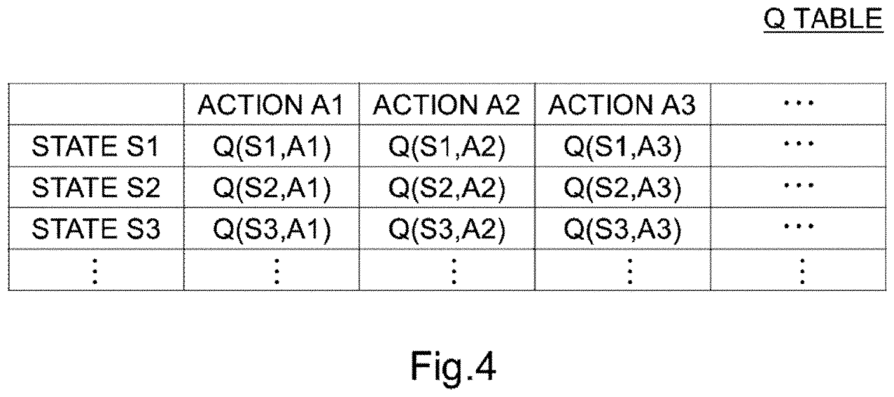

In the ε-greedy scheme, an action is selected at random with a probability ε, and an action having the highest value is selected with a probability 1−ε. Performing the Q-learning allows a Q table as illustrated in FIG. 4 to be generated.

### [Learning Using DQN]

The control apparatus 20 may control the network on the basis of a learning model obtained as a result of the reinforcement learning using a deep learning called Deep Q Network (DQN). The Q-learning expresses the action-value function using the Q table, whereas the DQN expresses the action-value function using the deep learning. In the DQN, an optimal action-value function is calculated by way of an approximate function using a neural network.

Note that the optimal action-value function is a function for outputting value of taking a certain action a in a certain state s.

The neural network is provided with an input layer, an intermediate layer (hidden layer), and an output layer. The input layer receives the state s as input. A link of each of nodes in the intermediate layer has a corresponding weight. The output layer outputs the value of the action a.

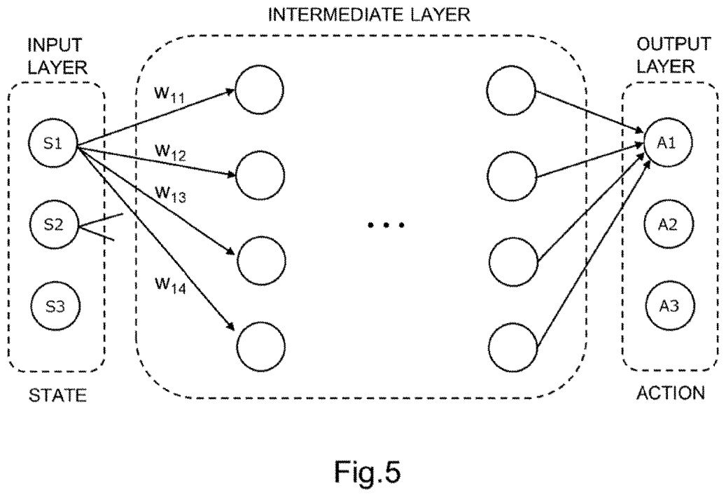

For example, consider a configuration of a neural network as illustrated in FIG. 5. Applying the neural network illustrated in FIG. 5 to the communication network system, nodes in the input layer correspond to network states S1 to S3. The network states input in the input layer are weighted in the intermediate layer and output to the output layer.

Nodes in the output layer correspond to possible actions A1 to A3 that the control apparatus 20 may take. The nodes in the output layer output values of the action-value function Q(sₜ, aₜ) corresponding to the action A1 to A3, respectively.

The DQN learns connection parameters (weights) between the nodes outputting the action-value function. Specifically, an error function expressed by Equation (3) below is set to perform learning by backpropagation.

[Math. 3]

E(sₜ,aₜ)=(rₜ₊₁+γ maxₐ_{ₜ₊₁}Q(sₜ₊₁,aₜ₊₁)−Q(sₜ,aₜ))² (3)

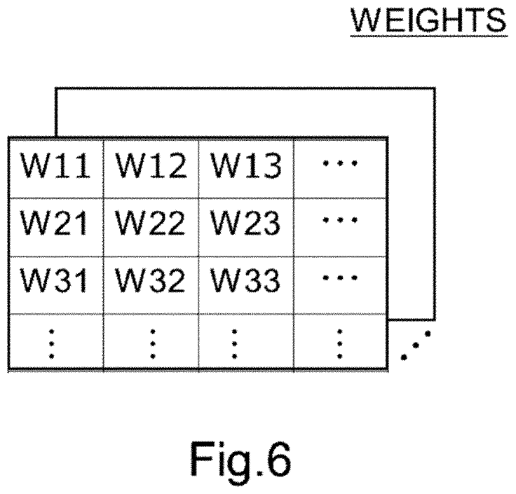

The DQN performing the reinforcement learning allows learning information (weights) to be generated that corresponds to a configuration of the intermediate layer of the prepared neural network (see FIG. 6).

Here, an operation mode for the control apparatus 20 includes two operation modes.

A first operation mode is a learning mode to calculate a learning model. The control apparatus 20 performing the “Q-learning” allows the Q table as illustrated in FIG. 4 to be calculated. Alternatively, the control apparatus 20 performing the reinforcement learning using the “DQN” allows the weights as illustrated in FIG. 6 to be calculated.

A second operation mode is a control mode to control the network using the learning model calculated in the learning mode. Specifically, the control apparatus 20 in the control mode calculates a current network state s to select an action a having the highest value of the possible actions a which may be taken in a case of the state s. The control apparatus 20 performs an operation (control of network) corresponding to the selected action a.

The control apparatus 20 according to the first example embodiment calculates the learning model per a congestion state of the network. For example, in a case that the congestion state of the network is classified into three stages, three learning models corresponding to the respective congestion states are calculated. Note that in the following description, the congestion state of the network is expressed by the “congestion level”.

The control apparatus 20, in the learning mode, calculates the learning model (the learning information such as the Q table or the weights) corresponding to each congestion level. The control apparatus 20 selects a learning model corresponding to a current congestion level among a plurality of learning models (the learning models for the respective congestion levels) to control the network.

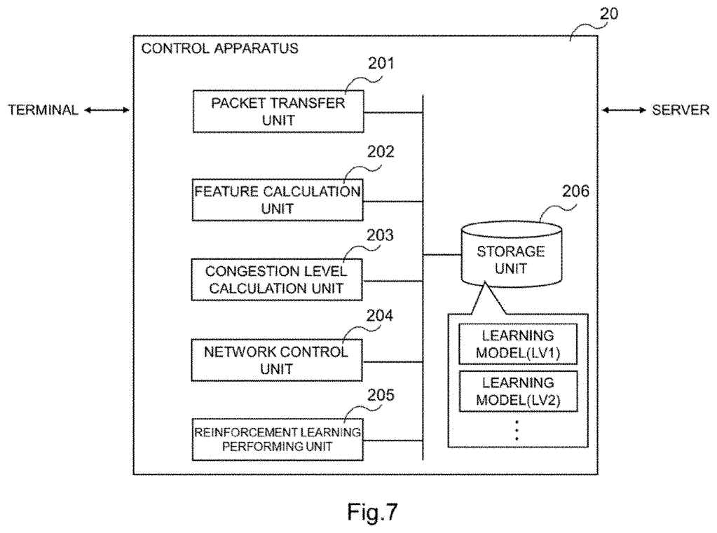

FIG. 7 is a diagram illustrating an example of a processing configuration (a processing module) of the control apparatus 20 according to the first example embodiment. With reference to FIG. 7, the control apparatus 20 is configured to include a packet transfer unit 201, a feature calculation unit 202, a congestion level calculation unit 203, a network control unit 204, a reinforcement learning performing unit 205, and a storage unit 206.

The packet transfer unit 201 is a means for receiving packets transmitted from the terminal 10 or the server 30 to transfer the received packets to an opposite apparatus. The packet transfer unit 201 performs the packet transfer in accordance with a control parameter notified from the network control unit 204.

For example, the packet transfer unit 201 performs, when getting notified of a configuration value of the flow window size from the network control unit 204, the packet transfer using the notified flow window size.

The packet transfer unit 201 delivers a duplication of the received packets to the feature calculation unit 202.

The feature calculation unit 202 is a means for calculating a feature featuring a communication traffic between the terminal 10 and the server 30. The feature calculation unit 202 extracts a traffic flow to be a target of network control from the obtained packets. Note that the traffic flow to be a target of network control is a group consisting of packets having the identical source (Internet Protocol) IP address, destination IP address, port number, or the like.

The feature calculation unit 202 calculates the feature from the extracted traffic flow. For example, the feature calculation unit 202 calculates, as the feature, a throughput, an average packet arrival interval, a packet loss rate, a jitter, or the like. The feature calculation unit 202 stores the calculated feature with a calculation time in the storage unit 206. Note that the calculation of the throughput or the like can be made by use of existing technologies, and is obvious to those of ordinary skill in the art, and thus, a detailed description thereof is omitted.

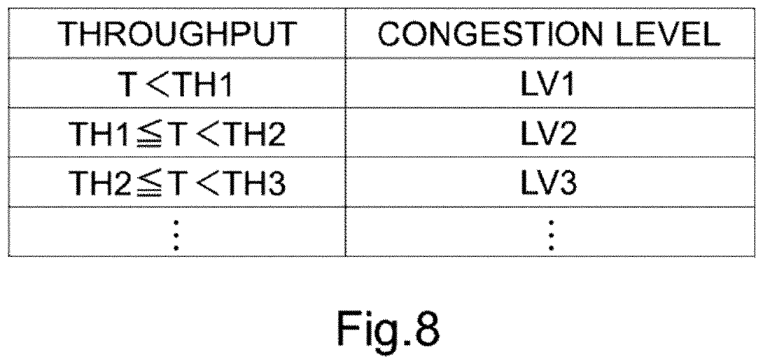

The congestion level calculation unit 203 calculates the congestion level indicating a degree of network congestion on the basis of the feature calculated by the feature calculation unit 202. For example, the congestion level calculation unit 203 may calculate the congestion level in accordance with a range in which the feature (for example, throughput) is included. For example, the congestion level calculation unit 203 may calculate the congestion level on the basis of table information as illustrated in FIG. 8.

In the example in FIG. 8, if a throughput T is equal to or more than a threshold TH1 and less than a threshold TH2, the congestion level is calculated to be “2”.

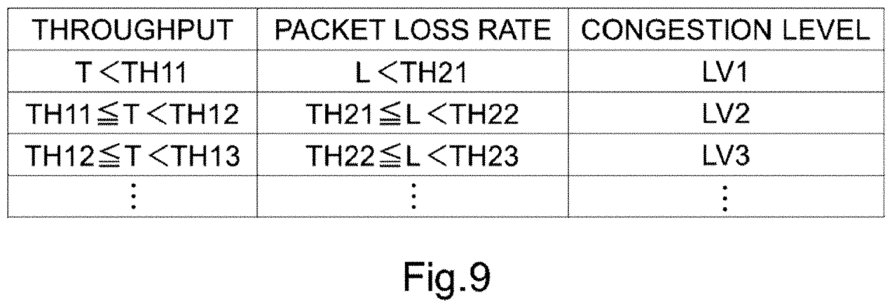

The congestion level calculation unit 203 may calculate the congestion level on the basis of a plurality of features. For example, the congestion level calculation unit 203 may use the throughput and the packet loss rate to calculate the congestion level. In this case, the congestion level calculation unit 203 calculates the congestion level on the basis of table information as illustrated in FIG. 9. For example, in the example in FIG. 9, in a case that the throughput T is included in a range “TH11≤T<TH12” and the packet loss rate is included in a rage “TH21≤L<TH22”, the congestion level is calculated to be “2”.

The congestion level calculation unit 203 delivers the calculated congestion level to the network control unit 204 and the reinforcement learning performing unit 205.

The network control unit 204 is a means for controlling the network on the basis of the action obtained from the learning model generated by the reinforcement learning performing unit 205. The network control unit 204 decides the control parameter to be notified to the packet transfer unit 201 on the basis of the learning model obtained as a result of the reinforcement learning. At this time, the network control unit 204 selects one learning model from among the plurality of learning models to control the network on the basis of an action obtained from the selected learning model. The network control unit 204 is a module mainly operating in the control mode.

The network control unit 204 selects the learning model (the Q table, the weights) depending on the congestion level notified from the congestion level calculation unit 203. Next, the network control unit 204 reads out the latest feature (at a current time) from the storage unit 206.

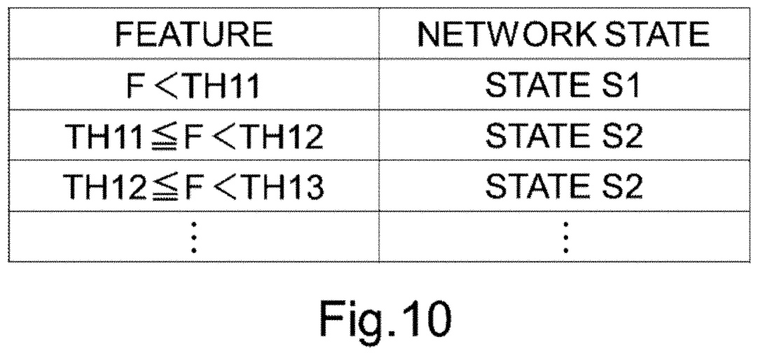

The network control unit 204 estimates (calculates) a state of the network to be controlled from the read feature. For example, the network control unit 204 references a table associating a feature F with a network state (see FIG. 10) to calculate the network state for the current feature F.

Note that a traffic is caused by communication between the terminal 10 and the server 30, and thus, the network state can be recognized also as a “traffic state”. In other words, in the present disclosure, the “traffic state” and the “network state” can be interchangeably interpreted.

FIG. 10 illustrates the case that the network state is calculated from the feature F independently from the congestion level, but the feature may be associated with network state per a congestion level.

In a case that the learning model is established by the Q-learning, the network control unit 204 references the Q table selected depending on the congestion level to acquire an action having the highest value Q of the actions corresponding to the current network state. For example, in the example in FIG. 4, if the calculated traffic state is a “state S1”, and value Q(S1, A1) is maximum among the value Q(S1, A1), Q(S1, A2), and Q(S1, A3), an action A1 is read out.

Alternatively, in a case that the learning model is established by the DNQ, the network control unit 204 applies the weights selected depending on the congestion level to a neural network as illustrated in FIG. 5. The network control unit 204 inputs the current network state to the neural network to acquire an action having the highest value of the possible actions.

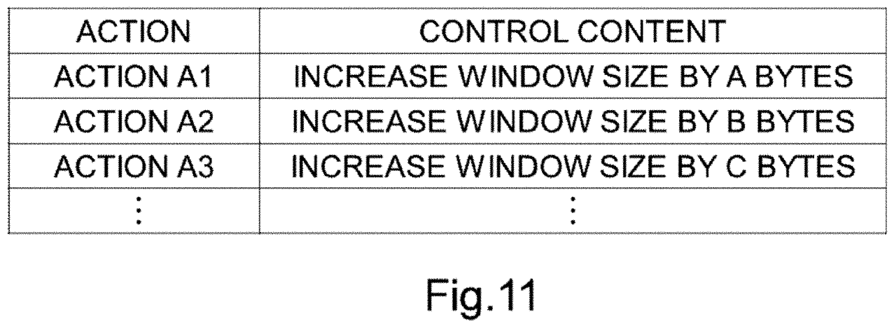

The network control unit 204 decides a control parameter depending on the acquired action to configure (notify) the decided control parameter for the packet transfer unit 201. Note that a table associating an action with control content (see FIG. 11) is stored in the storage unit 206, and the network control unit 204 references the table to decide the control parameter configured for the packet transfer unit 201.

For example, as illustrated in FIG. 11, in a case that changed content (updated content) of the control parameter is described as the control content, the network control unit 204 notifies the packet transfer unit 201 of the control parameter depending on the changed content.

The reinforcement learning performing unit 205 is a means for learning an action for controlling a network (a control parameter). The reinforcement learning performing unit 205 performs the reinforcement learning by the Q-learning or the DQN described above to generate a learning model. The reinforcement learning performing unit 205 is a module mainly operating in the learning mode.

The reinforcement learning performing unit 205 calculates the network state s at the current time t from the feature stored in the storage unit 206. The reinforcement learning performing unit 205 selects an action a from among the possible actions a in the calculated state s by a method like the ε-greedy scheme. The reinforcement learning performing unit 205 notifies the packet transfer unit 201 of the control content (the updated value of the control parameter) corresponding to the selected action. The reinforcement learning performing unit 205 decides a reward in accordance with a change in the network depending on the action.

For example, the reinforcement learning performing unit 205 sets a reward rₜ₊₁ described in Relationship (2) or Equation (3) to a positive value if the throughput increases as a result of taking the action a. In contrast, the reinforcement learning performing unit 205 sets a reward rₜ₊₁ described in Relationship (2) or Equation (3) to a negative value if the throughput decreases as a result of taking the action a.

The reinforcement learning performing unit 205 generates a learning model per a congestion level.

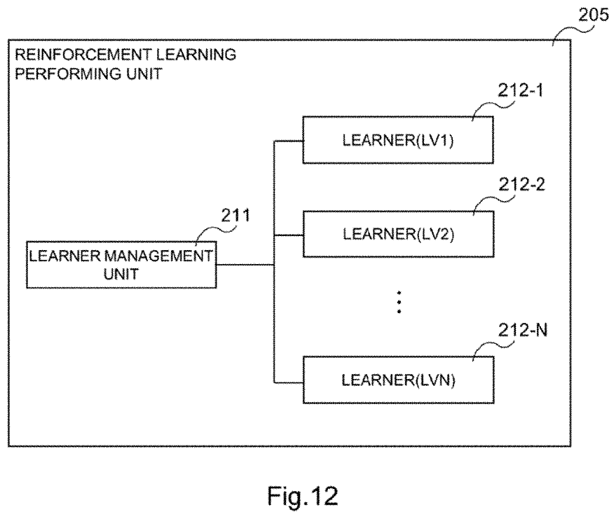

FIG. 12 is a diagram illustrating an example of an internal configuration of the reinforcement learning performing unit 205. With reference to FIG. 12, the reinforcement learning performing unit 205 is configured to include a learner management unit 211 and a plurality of learners 212-1 to 212-N (N represent a positive integer, which applies to the following).

Note that in the following description, the plurality of learners 212-1 to 212-N, in a case of no special reason for being distinguished, are expressed simply as the “learner 212”.

The learner management unit 211 is means for managing an operation of the learner 212.

Each of the plurality of learners 212 learns an action for controlling the network. The learner 212 is prepared per a congestion level. In FIG. 12, the corresponding congestion level is described in parentheses.

The learner 212 calculates the learning model (the Q table, the weights applied to the neural network) per a congestion level to store the calculated learning model in the storage unit 206.

In the first example embodiment, assume that a configuration of the Q table or a configuration of the neural network of each learner 212 prepared per a congestion level is identical. Specifically, the number of elements (the number of states s or the number of actions a) of the Q table generated per a congestion level is identical. A structure of an array storing the weights generated per a congestion level is identical.

For example, a configuration of an array managing weights applied to the learner 212-1 at a level 1 can be the same as a configuration of an array managing weights applied to the learner 212-2 at a level 2.

The learner management unit 211 selects a learner 212 corresponding to the congestion level notified from the congestion level calculation unit 203. The learner management unit 211 instructs the selected learner 212 to start learning. The instructed learner 212 performs the reinforcement learning by the Q-learning or the DQN described above.

At this time, the learner 212 notifies the learner management unit 211 of an index indicating a progress of the learning (hereinafter, referred to as a learning degree). For example, the learner 212 notifies the learner management unit 211 of the number of updates of the Q table or the number of updates of the weights as the learning degree.

The learner management unit 211 determines, on the basis of the obtained learning degree, whether the learning by each learner 212 sufficiently progresses (or whether the learner learns learning patterns from a prescribed number of events which are considered to enable the learner to properly make decision), or whether the learning by each learner 212 is insufficient. Note that in the present disclosure, a situation where the learning of the learner 212 sufficiently progresses and the mature learning information (the Q table, the weights) is obtained is expressed as “the learner is mature”. A situation where the learning of the learner 212 is insufficient and the mature learning information is not obtained (or a situation where the immature learning information is obtained) is expressed as “the learner is immature”.

Specifically, the learner management unit 211 performs threshold processing (for example, processing to determine whether an obtained value is not less than, or less than a threshold) on the learning degree obtained from the learner 212 to determine, in accordance with a result of the processing, a learning state of the learner 212 (specifically, whether the learner 212 is mature or immature). For example, the learner management unit 211 determines that the learner 212 is mature if the learning degree is not less than the threshold, or determines that the learner 212 is not mature if the learning degree is smaller than the threshold.

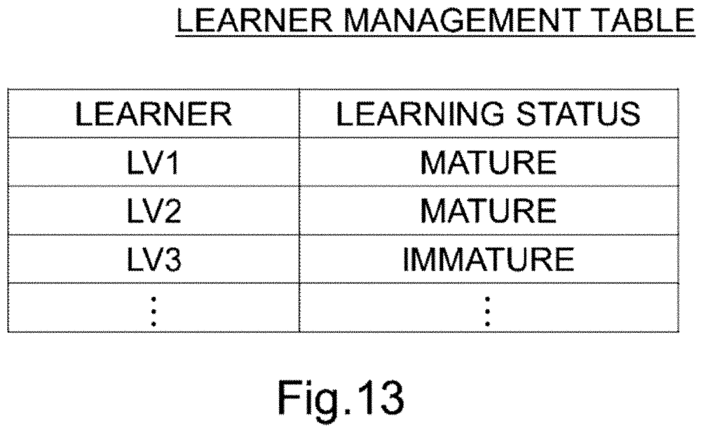

The learner management unit 211 reflects the result of determining the learning state to a learner management table stored in the storage unit 206 (see FIG. 13).

Because the learner 212 is prepared per a congestion level, a difference is generated in the learning progress depending on a situation of the network. In other words, the network state changes as a result of an action selected by the ε-greedy scheme or the like, and if the change in the network (state transition) is biased, the calculated congestion level is also biased. If the congestion level is biased, a situation may occur where a specific learner 212 become early mature, but learning of another learner 212 little progresses.

As such, in a case that an immature learner 212 is present after a prescribed time period elapses from when the control apparatus 20 transitions to the learning mode, or at a prescribed timing, the learner management unit 211 promotes the learning of the immature learner 212.

Specifically, the learner management unit 211 copies the Q table or the weights of the mature learner 212 into the Q table or the weights of the immature learner 212. At this time, the learner management unit 211 decides the learner 212 that is a copy source of the Q table or the weights on the basis of the congestion level assigned to each learner 212. For example, the learner management unit 211 copies a Q table or weights of a learner 212 assigned with a congestion level that is close to that of the immature learner 212 into the Q table or the weights of the immature learner 212.

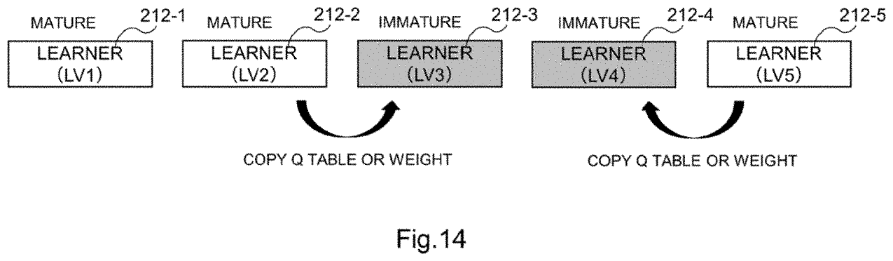

For example, as illustrated in FIG. 14, if a learner 212 at a congestion level 3 is immature, a Q table or weights of a learner 212 at a congestion level 2 that is close to the congestion level of the immature learner 212 is copied as the weights of the learner 212 at the congestion level 3. Similarly, if a learner 212 at a congestion level 4 is immature, a Q table or weights of a mature learner 212 assigned with a congestion level that is close to that of the immature learner (i.e., on the immediate right side of the congestion level 4 in FIG. 14) is copied as the Q table or the weights of the learner 212 at the congestion level 4.

In the first example embodiment, the congestion level calculation unit 203 calculates the congestion level indicating congestion state of the network. The congestion level is assigned to each of the plurality of learners 212. The learner management unit 211 sets learning information of a second learner that is immature (for example, the learner 212-3 in FIG. 14) based on learning information of a first learner that is mature (for example, the learner 212-2 in FIG. 14) among the plurality of learners 212. At this time, the learner management unit 211 selects the first learner of which the learning information is used for the setting for the second learner, on the basis of the congestion level assigned to the second learner.

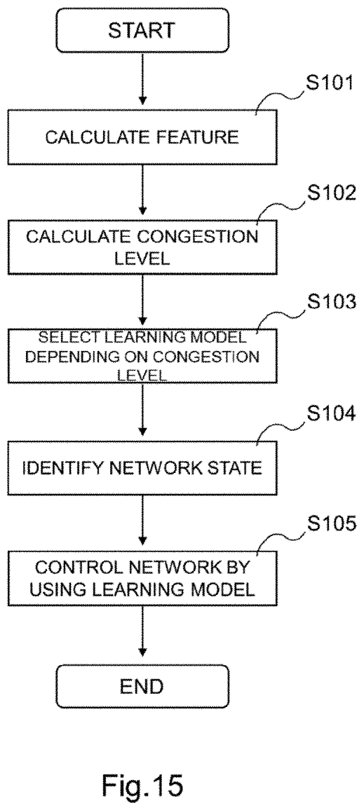

Summarizing the operations of the control apparatus 20 in the control mode according to the first example embodiment, a flowchart as illustrated in FIG. 15 is obtained.

The control apparatus 20 acquires packets to calculate a feature (step S101). The control apparatus 20 calculates a congestion level of the network on the basis of the calculated feature (step S102). The control apparatus 20 selects a learning model depending on the congestion level (step S103). The control apparatus 20 identifies a network state on the basis of the calculated feature (step S104). The control apparatus 20 uses the learning model selected in step S103 to control the network using an action having the highest value depending on the network state (step S105).

Note that the network control unit 204 in the control apparatus 20 refers the learner management table stored in the storage unit 206 (see FIG. 13) to check whether or not the selected learner 212 is immature. As a result of the check, if the selected learner 212 is immature, the network control unit 204 may not use the learning model generated by the learner 212 and may not change the control parameter. Alternatively, the network control unit 204 may select a learner 212 of which a congestion level is close to that of the selected learner 212 to decide the control parameter. However, in this case, because an action obtained from the learner 212 not matching the congestion level is selected, the network control unit 204 may gradually update the control parameter corresponding to the action. Specifically, the network control unit 204 may multiply the obtained control parameter by a value smaller than 1 to suppress an effect on the change in the network due to changing the control parameter.

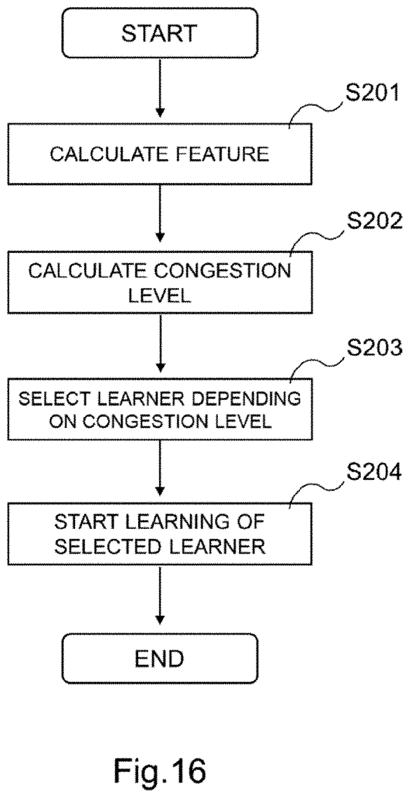

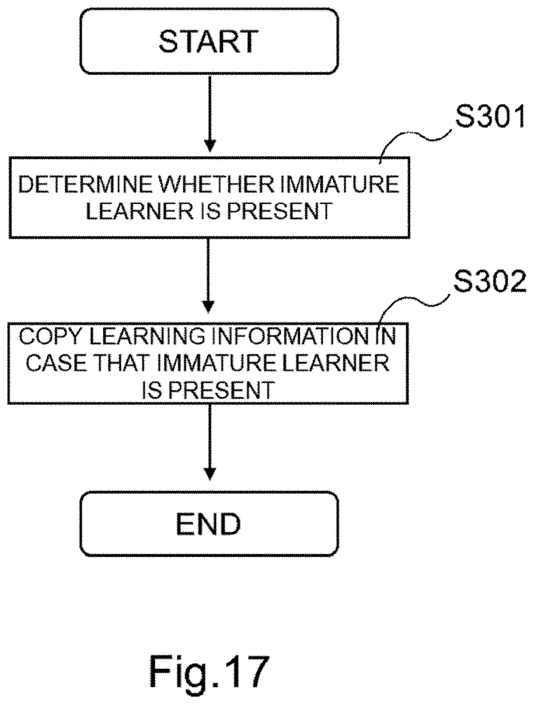

Summarizing the operations of the control apparatus 20 in the learning mode according to the first example embodiment, flowcharts as illustrated in FIGS. 16 and 17 are obtained.

FIG. 16 is a flowchart illustrating an example of a basic operation of the control apparatus 20 in the learning mode.

The control apparatus 20 acquires packets to calculate a feature (step S201). The control apparatus 20 calculates a congestion level of the network on the basis of the calculated feature (step S202). The control apparatus 20 selects a target learner 212 to perform learning depending on the congestion level (step S203). The control apparatus 20 starts learning of the selected learner 212 (step S204). To be more specific, the selected learner 212 performs learning by use of a group of packets (a group of packets including packets observed in the past) observed while a condition that the learner 212 is selected (the congestion level) is satisfied.

FIG. 17 is a flowchart illustrating an example of an operation performed by the control apparatus 20 in the learning mode periodically or at a prescribed timing.

The control apparatus 20 determines, with a prescribed period, at a prescribed timing, or the like, whether or not an immature learner 212 is present (step S301). If an immature learner 212 is present, and a learner 212 of which a congestion level is close to that of the immature learner 212 is mature, the control apparatus 20 copies learning information (Q table, weights) of the mature learner 212 into learning information of the immature learner 212 (step S302). Note that the prescribed period is a period of, for example, every one hour, every day, or the like. The prescribed timing is a timing when, for example, the target learner 212 to perform learning is switched with the network state (the congestion level) being switched.

As described above, in the first example embodiment, a plurality of learners (reinforcement learners) are prepared. The reason why is that the network state includes variable patterns such as a stable state and an unstable state, and thus, a huge state space is required in a case of learning by a single learner and the learning may not be converged. However, in the case of using a plurality of learners, a bias occurs in learning progresses of the learners so that an immature learner (a learner not progressing the learning) increases. Accordingly, a learning method is required which takes the bias related to the learning of the learners into account, and is efficient for an immature learner.

The control apparatus 20 according to the first example embodiment transfers the learning information of the mature learner to the immature learner to achieve a learning period shortened. At this time, the control apparatus 20 selects a transfer source learner in consideration of a relation between the network congestion levels to perform more accurate transfer learning. In other words, it is assumed that the learning information (the Q tables, the weights) finally output by the learners of which the congestion levels are close to each other have the contents close to each other even including some differences. Specifically, the fact that the congestion levels are close to each other means that the environments (the networks) targeted by the respective learners are similar to each other, and thus, also means that the learning information for taking an optimal action is similar (closer). As such, the control apparatus 20 sets the learning information of the immature learner to be the learning information generated by the mature learner to shorten a time taken from starting the learning until the learner becomes mature (a distance between the learning information). As a result, the learning efficient for the immature learner is achieved.

### Second Example Embodiment

Subsequently, a second example embodiment is described in detail with reference to the drawings.

The first example embodiment assumes that the configuration of the Q table or the weights is in common between the learning models. However, if the congestion level is different, a structure of the optimal learning model (the configuration of the Q table or the weights) may be also different. In such a case, as in the first example embodiment, the Q table or the weights of the close mature learner 212 cannot be copied into (transferred to, set as) the Q table or the weights of the immature learner 212.

The second example embodiment describes that in the case that the configuration of the Q table or the weights is different, the learning of the immature learner 212 is promoted.

Each learner 212 calculates log information about the generation of the learning model. Specifically, each learner 212 stores a set of a network state (status) and an action used in the learning as a log.

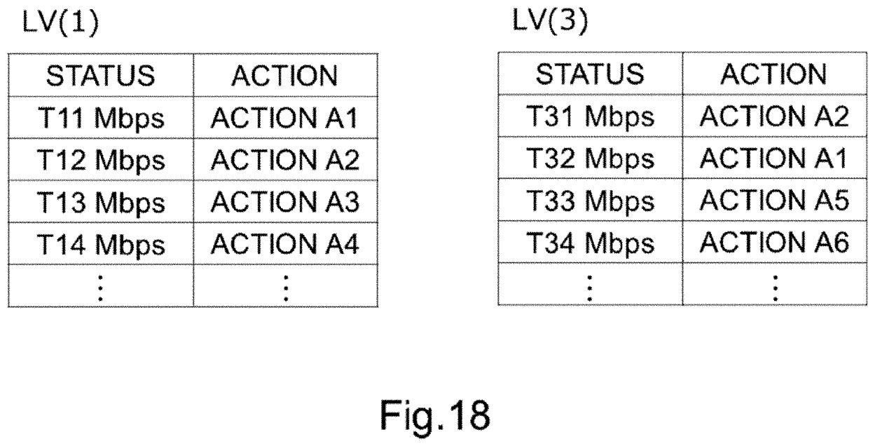

For example, the learner 212 generates a log as illustrated in FIG. 18 to store the generated log in the storage unit 206. With reference to FIG. 18, the learner 212-1 generating a learning model of the congestion level 1 generates a log including a throughput and an action. Similarly, the learner 212-3 generating a learning model of the congestion level 3 generates a log including a throughput and an action.

In a case that an immature learning model (the Q table, the weights) is present at a prescribed timing, the learner management unit 211 uses the log of the mature learner 212 to cause the immature learner 212 to perform learning. To be more specific, the learner management unit 211 performs processing on the logs generated by the learners 212 located on both next sides of the immature learner 212 (the learners of which the congestion levels are close next to each other) to generate a learning log.

The learner management unit 211 extracts logs in which an action is common from two logs generated by the learners 212 on the both next sides of the immature learner 212. For example, in the example in FIG. 18, an action A1 and an action A2, which are common in two logs, are extracted.

The learner management unit 211 calculates a median value (an average value) of the statuses for the same action among the extracted logs. In the example in FIG. 18, an average value of T11 Mbps and T32 Mbps for the action A1, and an average value of T12 Mbps and T31 Mbps for the action A2 are calculated.

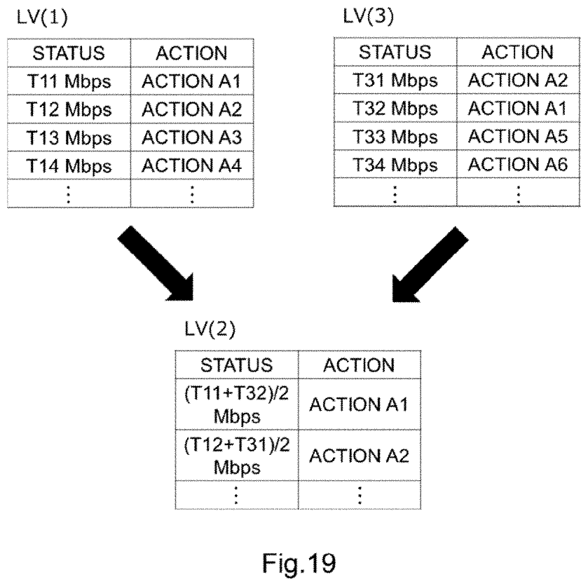

The learner management unit 211 generates, as a learning amount log, the actions and the average value of the actions. For example, a learning log as illustrated in FIG. 19 is generated from the log illustrated in FIG. 18. The learner management unit 211 delivers the learning log generated as described above to the immature learner 212 to cause the immature learner 212 to perform learning. For example, the immature learner 212-2 performs learning by use of a log for the learning log illustrated in FIG. 19 to generate the learning information (the Q table, the weights) depending on the congestion level 2.

As described above, in the second example embodiment, the learning information of the second learner (the learner corresponding to the level 2) is set based on the learning information of the first learner and a third learner that are mature among the plurality of learners 212 (the learners corresponding to the levels 1 and 3 in the example in FIG. 18, for example). As a result, even if the configurations or structures of the learning information generated by the respective learners 212 are different from each other, the learning of the immature learner can be promoted.

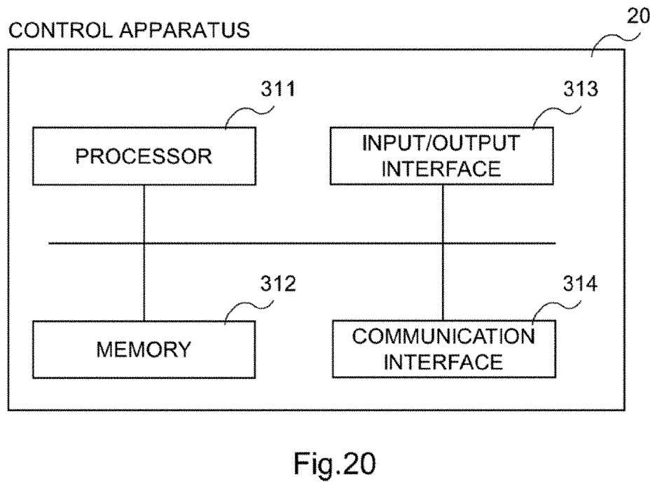

Next, hardware of each apparatus configuring the communication network system will be described. FIG. 20 is a diagram illustrating an example of a hardware configuration of the control apparatus 20.

The control apparatus 20 can be configured with an information processing apparatus (so-called, a computer), and includes a configuration illustrated in FIG. 20. For example, the control apparatus 20 includes a processor 311, a memory 312, an input/output interface 313, a communication interface 314, and the like. Constituent elements such as the processor 311 are connected to each other with an internal bus or the like, and are configured to be capable of communicating with each other.

However, the configuration illustrated in FIG. 20 is not intended to limit the hardware configuration of the control apparatus 20. The control apparatus 20 may include hardware not illustrated, or need not include the input/output interface 313 as necessary. The number of processors 311 and the like included in the control apparatus 20 is not intended to limit to the example illustrated in FIG. 20, and for example, a plurality of processors 311 may be included in the control apparatus 20.

The processor 311 is, for example, a programmable device such as a central processing unit (CPU), a micro processing unit (MPU), and a digital signal processor (DSP). Alternatively, the processor 311 may be a device such as a field programmable gate array (FPGA) and an application specific integrated circuit (ASIC). The processor 311 executes various programs including an operating system (OS).

The memory 312 is a random access memory (RAM), a read only memory (ROM), a hard disk drive (HDD), a solid state drive (SSD), or the like. The memory 312 stores an OS program, an application program, and various pieces of data.

The input/output interface 313 is an interface of a display apparatus and an input apparatus (not illustrated). The display apparatus is, for example, a liquid crystal display or the like. The input apparatus is, for example, an apparatus that receives user operation, such as a keyboard and a mouse.

The communication interface 314 is a circuit, a module, or the like that performs communication with another apparatus. For example, the communication interface 314 includes a network interface card (NIC) or the like.

The function of the control apparatus 20 is implemented by various processing modules. Each of the processing modules is, for example, implemented by the processor 311 executing a program stored in the memory 312. The program can be recorded on a computer readable storage medium. The storage medium can be a non-transitory storage medium, such as a semiconductor memory, a hard disk, a magnetic recording medium, and an optical recording medium. In other words, the present invention can also be implemented as a computer program product. The program can be updated through downloading via a network, or by using a storage medium storing a program. In addition, the processing module may be implemented by a semiconductor chip.

Note that the terminal 10 and the server 30 also can be configured by the information processing apparatus similar to the control apparatus 20, and their basic hardware structures are not different from the control apparatus 20, and thus, the descriptions thereof are omitted.

### Example Alterations

Note that the configuration, the operation, and the like of the communication network system described in the example embodiments are merely examples, and are not intended to limit the configuration and the like of the system. For example, the control apparatus 20 may be separated into an apparatus controlling the network and an apparatus generating the learning model. Alternatively, the storage unit 206 storing the learning information (the learning model) may be achieved by an external database server or the like. In other words, the present disclosure may be implemented as a system including a learning means, a control means, a storage means, and the like.

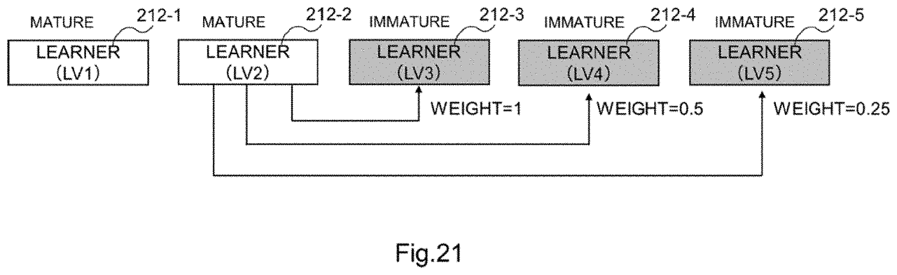

In the example embodiments, the learning information of the mature learner 212 of which the congestion level is close to that of the immature learner 212 is copied into the learning information of the immature learner 212. However, no mature learner 212 may be present of which the congestion level is close to the congestion level of the immature learner 212. In this case, the learning information to be copied may be weighted depending on a distance between the congestion levels of the immature learner 212 and the mature learner 212. For example, as illustrated in FIG. 21, there may be a case that the learnings of the learner 212-1 and the learner 212-2 are mature, and the learners 212-3 to 212-5 are immature. In this case, the learner management unit 211 copies the learning information of the learner 212-2 without change (weight=1) into the learning information of the learner 212-3 of which the congestion level is close to that of the learner 212-2. The learner management unit 211 may halve value of the learning information of the learner 212-2 and copy the resultant learning information (weight=0.5) into the learning information of the learner 212-4 of which the congestion level is at a distance of one level from the learner 212-2. Similarly, the learner management unit 211 may quarter value of the learning information of the learner 212-2 and copy the resultant learning information (weight=0.25) into the learning information of the learner 212-5 of which the congestion level is at a distance of two levels from the learner 212-2.

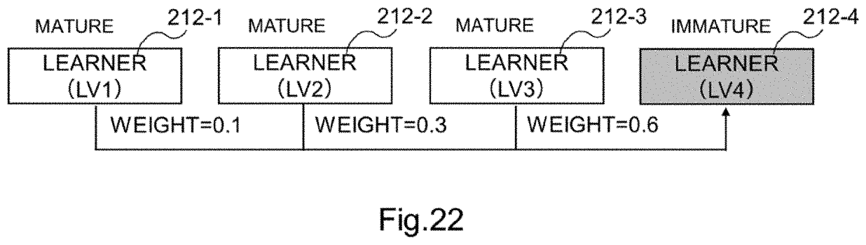

Alternatively, the learning information of the immature learner 212 may be set to be the learning information generated by a plurality of mature learners 212 rather than copying the learning information from one learner 212 into the learning information of the immature learner 212. At this time, the learner management unit 211 may change a degree of effect of the learning information generated by the mature learner 212 depending on the congestion level. For example, as illustrated in FIG. 22, assume a case that the learners 212-1 to 212-3 are mature and the learner 212-4 is immature. In this case, the learner management unit 211 may generate the learning information set for the immature learner 212 by way of weighted averaging in which the closer the congestion level is to that of the immature learner 212, the larger weight is given. In the example in FIG. 22, the learning information of the learner 212-3 of which the congestion level is close to the immature learner is given a weight of “0.6”, the learning information of the learner 212-2 of which the congestion level is at a distance of one level is given a weight of “0.3”, and the learning information of the learner 212-1 of which the congestion level is at a distance of two levels is given a weight of “0.1”.

The example in FIG. 22 describes the case that the mature learner 212 is present on one next side of the immature learner 212 (on the left side, a side where the congestion level is smaller), but even in a case that the mature learners 212 are present on both sides of the immature learner 212, the learning information can be generated in the same way as described above. Specifically, if the learners 212 on the both next sides of the immature learner 212 are mature, the learner management unit 211 may give a weight of 0.5 to the learning information of the both side learners 212 to generate the learning information using the total value thereof.

The example embodiments describe the case that the control apparatus 20 use the traffic flow as a target of control (as one unit of control). However, the control apparatus 20 may use an individual terminal 10 or a group collecting a plurality of terminals 10 as a target of control. Specifically, the flows even in the identical terminal 10 are handled as different flows because if the applications are different, port numbers are different. The control apparatus 20 may apply the same control (changing the control parameter) to the packets transmitted from the identical terminal 10. Alternatively, the control apparatus 20 may handle, for example, the same type of terminals 10 as one group to apply the same control to the packets transmitted from the terminals 10 belonging to the same group.

In a plurality of flowcharts used in the above description, a plurality of steps (processes) are described in order, but the order of performing of the steps performed in each example embodiment is not limited to the described order. In each example embodiment, the illustrated order of processes can be changed as far as there is no problem with regard to processing contents, such as a change in which respective processes are executed in parallel, for example. The example embodiments described above can be combined within a scope that the contents do not conflict.

The whole or part of the example embodiments disclosed above can be described as in the following supplementary notes, but are not limited to the following.

### (Supplementary Note 1)

A control apparatus (20, 100) including:

a plurality of learners (101, 212) each configured to learn an action for controlling a network; and

a learner management unit (102, 211) configured to set learning information of a second learner (101, 212) that is not mature among the plurality of learners (101, 212), based on learning information of a first learner (101, 212) that is mature among the plurality of learners (101, 212).

### (Supplementary Note 2)

The control apparatus (20, 100) according to supplementary note 1, wherein the learner management unit (102, 211) is configured to set the learning information of the second learner (101, 212) based on learning information of the first learner and a third learner (101, 212) that are mature among the plurality of learners (101, 212).

### (Supplementary Note 3)

The control apparatus (20, 100) according to supplementary note 1 or 2, further including:

a congestion level calculation unit configured to calculate a congestion level indicating a congestion state of the network,

wherein the congestion level is assigned to each of the plurality of learners (101, 212).

### (Supplementary Note 4)

The control apparatus (20, 100) according to supplementary note 3, wherein the learner management unit (102, 211) is configured to select the first learner (101, 212) of which the learning information is used for the setting, based on the congestion level assigned to the second learner (101, 212).

### (Supplementary Note 5)

The control apparatus (20, 100) according to any one of supplementary notes 1 to 4, further including:

a control unit (204) configured to select one learning model from learning models generated by the plurality of learners and control the network based on an action obtained from the selected learning model.

### (Supplementary Note 6)

A method including:

learning an action for controlling a network in each of a plurality of learners (101, 212); and

setting learning information of a second learner (101, 212) that is not mature among the plurality of learners (101, 212), based on learning information of a first learner (101, 212) that is mature among the plurality of learners (101, 212).

### (Supplementary Note 7)

The method according to supplementary note 6, wherein the setting the learning information includes setting learning information of the second learner based on learning information of the first learner and a third learner (101, 212) that are mature among the plurality of learners.

### (Supplementary Note 8)

The method according to supplementary note 6 or 7, further including:

calculating a congestion level indicating a congestion state of the network,

wherein the congestion level is assigned to each of the plurality of learners (101, 212).

### (Supplementary Note 9)

The method apparatus according to supplementary note 8, wherein the setting the learning information includes selecting the first learner (101, 212) of which the learning information is used for the setting, based on the congestion level assigned to the second learner (101, 212).

### (Supplementary Note 10)

The method according to any one of supplementary notes 6 to 9, further including:

selecting one learning model from learning models generated by the plurality of learners (101, 212) and controlling the network based on an action obtained from the selected learning model.

### (Supplementary Note 11)

A system including:

a terminal (10);

a server (30) configured to communicate with the terminal; and

a control apparatus (20, 100) configured to control a network including the terminal (10) and the server (30),

wherein the control apparatus (20, 100) includes
a plurality of learners (101, 212) each configured to learn an action for controlling the network, and
a learner management unit (102, 211) configured to set learning information of a second learner (101, 212) that is not mature among the plurality of learners (101, 212) based on learning information of a first learner (101, 212) that is mature among the plurality of learners (101, 212).

### (Supplementary Note 12)

The system according to supplementary note 11, wherein the learner management unit (102, 211) is configured to set the learning information of the second learner (101, 212), based on learning information of the first learner and a third learner (101, 212) that are mature among the plurality of learners (101, 212).

### (Supplementary Note 13)

The system according to supplementary note 11 or 12, further including:

a congestion level calculation unit configured to calculate a congestion level indicating a congestion state of the network,

wherein the congestion level is assigned to each of the plurality of learners (101, 212).

### (Supplementary Note 14)

The system according to supplementary note 13, wherein the learner management unit (102, 211) is configured to select the first learner (101, 212) of which the learning information is used for the setting, based on the congestion level assigned to the second learner (101, 212).

### (Supplementary Note 15)

The system according to any one of supplementary notes 11 to 14, further including:

a control unit (204) configured to select one learning model from learning models generated by the plurality of learners (101, 212) and control the network based on an action obtained from the selected learning model.

### (Supplementary Note 16)

A program causing a computer (311) mounted on a control apparatus (20, 100) to execute the processes of:

learning an action for controlling a network in each of a plurality of learners (101, 212); and

setting learning information of a second learner (101, 212) that is not mature among the plurality of learners (101, 212), based on learning information of a first learner (101, 212) that is mature among the plurality of learners (101, 212).

Note that the disclosures of the cited literatures in the citation list are incorporated herein by reference. Descriptions have been given above of the example embodiments of the present invention. However, the present invention is not limited to these example embodiments. It should be understood by those of ordinary skill in the art that these example embodiments are merely examples and that various alterations are possible without departing from the scope and the spirit of the present invention.

### REFERENCE SIGNS LIST

10 Terminal
20, 100 Control Apparatus
30 Server
101, 212, 212-1 to 212-N Learner
102, 211 Learner Management Unit
201 Packet Transfer Apparatus
202 Feature Calculation Unit
203 Congestion Level Calculation Unit
204 Network Control Unit
205 Reinforcement Learning Performing Unit
206 Storage Unit
311 Processor
312 Memory
313 Input/Output Interface
314 Communication Interface

What is claimed is:

1. A control apparatus comprising:
a memory storing instructions; and
one or more processors configured to execute the instructions to function as a plurality of learners each configured to learn an action for controlling a network,
wherein the one or more processors are further configured to set learning information of a second learner that is not mature among the plurality of learners, based on learning information of a first learner that is mature among the plurality of learners.

2. The control apparatus according to claim 1, wherein the one or more processors are further configured to set the learning information of the second learner based on learning information of the first learner and a third learner that are mature among the plurality of learners.

3. The control apparatus according to claim 1, wherein the one or more processors are further configured to calculate a congestion level indicating a congestion state of the network,
wherein the congestion level is assigned to each of the plurality of learners.

4. The control apparatus according to claim 3, wherein the one or more processors are further configured to select the first learner of which the learning information is used for the setting, based on the congestion level assigned to the second learner.

5. The control apparatus according to claim 1, wherein the one or more processors are further configured to select one learning model from learning models generated by the plurality of learners and control the network based on an action obtained from the selected learning model.

6. A method comprising:
learning an action for controlling a network in each of a plurality of learners; and
setting learning information of a second learner that is not mature among the plurality of learners, based on learning information of a first learner that is mature among the plurality of learners.

7. The method according to claim 6, wherein the setting the learning information includes setting learning information of the second learner based on learning information of the first learner and a third learner that are mature among the plurality of learners.

8. The method according to claim 6, further comprising:
calculating a congestion level indicating a congestion state of the network,
wherein the congestion level is assigned to each of the plurality of learners.

9. The method apparatus according to claim 8, wherein the setting the learning information includes selecting the first learner of which the learning information is used for the setting, based on the congestion level assigned to the second learner.

10. The method according to claim 6, further comprising:
selecting one learning model from learning models generated by the plurality of learners and controlling the network based on an action obtained from the selected learning model.

11. A system comprising:
a terminal;
a server configured to communicate with the terminal; and
a control apparatus configured to control a network including the terminal and the server,
wherein the control apparatus includes a memory storing instructions, and one or more processors configured to execute the instructions to function as a plurality of learners each configured to learn an action for controlling the network, and
the one or more processors are further configured to set learning information of a second learner that is not mature among the plurality of learners based on learning information of a first learner that is mature among the plurality of learners.

12. The system according to claim 11, wherein the one or more processors are further configured to set the learning information of the second learner, based on learning information of the first learner and a third learner that are mature among the plurality of learners.

13. The system according to claim 11, wherein the one or more processors are further configured to calculate a congestion level indicating a congestion state of the network,
wherein the congestion level is assigned to each of the plurality of learners.

14. The system according to claim 13, wherein the one or more processors are further configured to select the first learner of which the learning information is used for the setting, based on the congestion level assigned to the second learner.

15. The system according to claim 11, wherein the one or more processors are further configured to select one learning model from learning models generated by the plurality of learners and control the network based on an action obtained from the selected learning model.
